(19) United States
(12) Patent Application Publication
(10) Pub. No.: US 2004/0228010 A1
(43) Pub. Date: Nov. 18, 2004

(54) INTEGRATED MICROSCOPIC VIEWING APPARATUS

(76) Inventor: Albert C. Wey, Westmont, IL (US)

Correspondence Address: Albert C. Wey, 233 E. 57th Street, Westmont, IL, 60559, US

(21) Appl. No.: 10/437,160

(22) Filed: May 13, 2003

(51) Int. Cl. G02B 27/02; G02B 21/34

(52) U.S. Cl. 359/804; 359/398

(57) ABSTRACT

This invention describes an integrated microscope with a removable transparent specimen-container that can be directly placed at just beyond the effective focal plane of said microscope, with which schoolchildren can collect live specimens and dispose the specimens in said specimen-container ready for instantaneous microscopic examination of the specimens at a magnification power 20× or higher in the field.

### BACKGROUND

1. Field of Invention

The present invention relates to an integrated microscope with a removable transparent specimen-container which can be directly placed at just beyond the effective focal plane of said microscope, providing an instantaneous high power magnification microscopic view of live specimens collected in the field, particularly suitable for schoolchildren.

2. Description of Prior Art

There have been a number of containers with integrated magnifying means invented for specific applications (for example, U.S. Pat. Nos. 6,092,646, 6,115,195, and 6,366,401) that use a simple-lens magnifier with a low power magnification typically less than 3×(three times). More complicated magnifiers employing a multiple-lens system to provide variable power zoom were also invented separately (e.g. U.S. Pat. Nos. 5,239,416 and 6,124,985) to provide an adjustable magnification power up to between 5× and 10×.

Meanwhile, the structure and construction of a classical optical microscope has been well known in the art. It is often equipped with a revolver for a plurality of lenses to facilitate selective magnifications. Many inventions were done only to evolve for enhanced features (e.g. U.S. Pat. Nos. 6,323,998 and 6,400,501). However, conventional microscopes are bulky, heavy and complex for children to use in the field. A portable microscope was consequently invented (U.S. Pat. No. 5,844,714) to simplify the construction and operation. Yet, this invention is still complicated enough for young schoolchildren to operate. Although the invention reveals the concept of portable microscope, it emphasizes more on the handgrip feature than the microscope itself. Also, the magnifying means used in the invention is rather a simple, low-power microscope with a typical magnification less than 5×, than a high-power one, whose magnification may be carried as high as 20× and higher.

A microscope differs itself from a magnifier not only on the power of magnification, but also on stringent needs in aberration correction and focus depth that are required to provide an undistorted microscopic view of specimen, particularly for live insects with significant thickness. The design of such is rather an art than a science. The prior art fails to teach a device that enables schoolchild to simply, directly, and effectively view and inspect a live specimen which has been collected in the field and placed in a specimen-container ready for instantaneous examination at high power magnification.

### OBJECTS AND ADVANTAGES

Accordingly, one object of this invention is to provide a compact, lightweight, easy to operate, and high magnification microscope for schoolchild to use in the filed.

Another object of the present invention is to provide a simple, one-step process in specimen preparation for immediate microscopic examination, particularly for live insects.

These objectives are achieved by an integrated microscope with a removable transparent specimen-container that can be directly placed at just beyond the effective focal plane of said microscope for instantaneous microscopic examination of live specimens.

Other objects, features and advantages of the present invention will hereinafter become apparent to those skilled in the art from the following description.

### DRAWING FIGURES

FIG. 1 shows a cross-sectional view illustrating one embodiment of the present invention, with a retractable microscope assembly and a transparent specimen-container which is placed at just beyond the effective focal plane of said microscope.

FIG. 2 shows the embodiment as described in FIG. 1 in full suppression mode.

FIG. 3 shows a cross-sectional view illustrating another embodiment of the present invention in a simplified microscope assembly.

### REFERENCE NUMERALS IN DRAWINGS

| | | | |
|---|---|---|---|
| 11 | Eyepiece lens | 12 | Objective lens- (1) |
| 13 | Objective lens- (2) | 21 | Eyepiece lens housing |
| 22 | Objective lens housing | 23 | Objective lens assembly |
| 31 | Specimen-container | 32 | Removable specimen-container |
| | holding means | | |

### SUMMARY

In accordance with the present invention an integrated microscope consists of a microscope assembly and a removable transparent specimen-container that can be directly placed at just beyond the effective focal plane of said microscope. Schoolchildren may collect live specimens in the field and dispose the specimens in said interchangeable, removable specimen-containers. They can inspect the specimens instantaneously by simply inserting said specimen-container into the specimen-container holding base of said microscope.

### DETAILED DESCRIPTION OF THE INVENTION

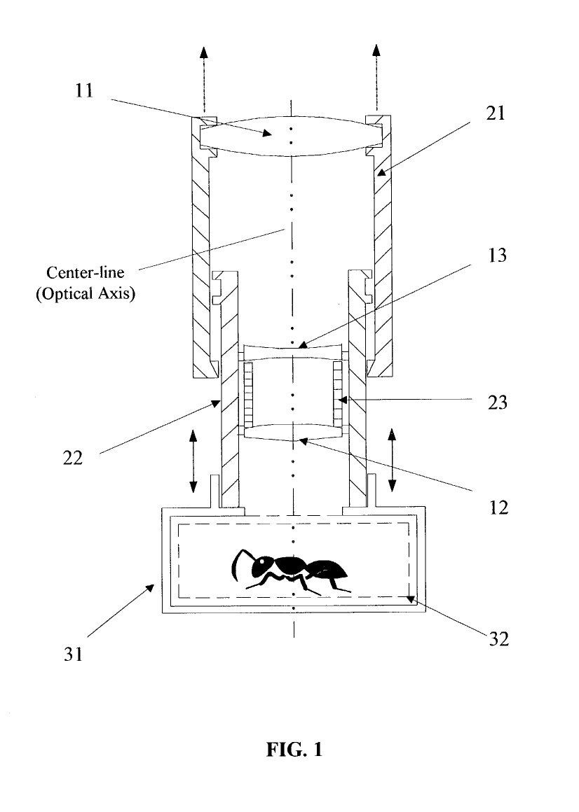

The device of the present invention consists of an eyepiece lens assembly, an objective lens assembly, and a removable specimen-container, as shown in FIG. 1. The eyepiece assembly comprises a convex lens 11 in a tube 21, while the objective lens assembly may comprise a concave lens 12 and a convex lens 13, assembled at a predetermined separation in the construction 23 which is placed in the tube 22. The eyepiece lens assembly 11 and objective lese assembly 12 & 13 are aligned and arranged to form an optical microscope.

The objective lens 11 can be formed by a single lens or a compound lese system such as Orthoscopic, Plossl, and Erfle, as known in the art. There are also many possibilities in forming objective lens system in order to provide a corrected view with minimal distortion, including Lister, Amici, Oil-immersion, Apochromatic, and others as known in the art. For example, a combination of a double-convex lens 12 and a double-concave lens 13 is selected to provide a longer back focal length (b.f.l.) while shortening the front focal length (f.f.l.). As a result, focus sensitivity on thick specimen may be eased by an elongated focal depth associated with the design. Meanwhile, the total length of microscope can also be reduced for ease of storing and carrying. The design of such is rather an art than a science.

The specimen-container 32 which is removable form the microscope assembly is made of transparent material like glass, plastics or acrylic, with an access allowing for transporting specimens in and out of the container. Several ventilating holes are furnished on sidewalls to keep live specimens alive. Specimens collected from the field can be placed in the specimen-container 32 for immediate or later inspection. When it is time for examination, the operator can simply insert the specimen-container 32 into specimen-container holding base 31 which is attached to the microscope for instantaneous microscopic viewing. The specimen-container holding base 31 is movable along the optical axis of the microscope to bring the inspecting specimen into focus, in order to accommodate various thickness specimens.

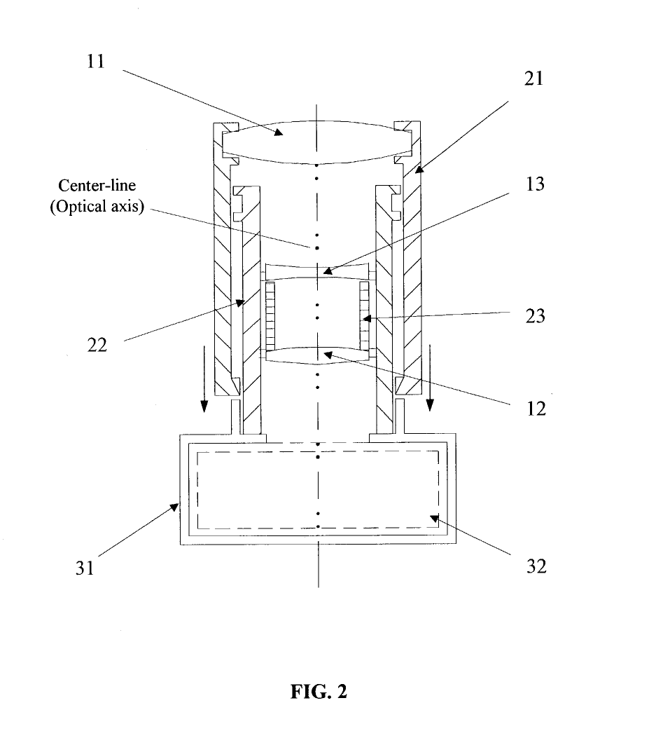

In FIG. 1, eyepiece lens assembly and objective lens assembly are designed to be in separated constructions in which eyepiece lens tube 21 is retractable against objective lens tube 22. The eyepiece lens tube 21 is retracted to its full extension position for microscope function. When not in use, it can be fully suppressed, as shown in FIG. 2, for saving space.

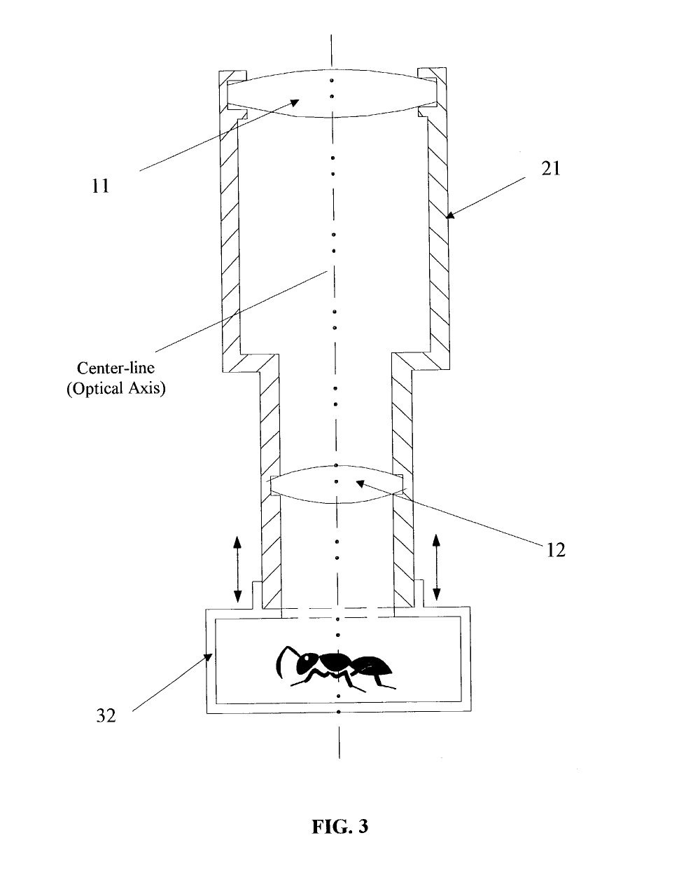

In cases whichever magnification power and viewing quality are not of major concerns, the embodiment of the present invention can be simplified to that as illustrated in FIG. 3. An eyepiece lens 11 and an objective lens 12 are assembled in a tube 21, being disposed apart from each other at a predetermined distance to form a simple microscope. The removable specimen-container 32, with a simple coupling means, is concentrically connected to the microscope and movable along the optical axis to provide a simple focus means.

First Embodiment

A compound objective lens system consisting of a concave lens (ƒ₁=−30 mm) and a convex lens (ƒ₂=+20 mm) was assembled at 10 mm apart. This objective lens system has an effective objective focal length ƒₒ=+30 mm, with a front focal length ƒ.ƒ.l.=15 mm and a back focal length b.ƒ.l.=40 mm. The distance from the second focus of the objective lens system to the first focus of eyepiece is set to be L=75 mm. A thin convex lens was chosen to be eyepiece lens with a focal length ƒₑ=25 mm The magnification power (M.P.) of the whole system was thus calculated to be:

M.P.=(−75/ƒₒ) (250/ƒₑ)=−25

As a result, the microscope had a 25× magnification power and was 165 mm in total length, from the top of eyepiece lens to the second focal point of the objective lens system.

For implementation, the eyepiece lens was disposed in an 85 mm long tube, while the objective lens assembly was separately placed in a 90 mm long tube. Such arrangement allowed a full extension to accommodate microscope length (i.e. 165 mm) and a full suppression with a 110 mm total length for ease of storing and carrying. The removable specimen-container was a clear box, about 40 mm long×40 mm wide×15 mm thick, which could be inserted into the specimen-container holding base that had been concentrically attached to the microscope assembly.

Second Embodiment

A simple microscope system was constructed to consist of a convex eyepiece lens (ƒₑ=25 mm) and a convex objective lens (ƒₒ=30 mm). The eyepiece lens and objective lens were placed at 130 mm apart, which added up 25 mm ƒₑ, 30 mm ƒₒ, and a 75 mm (so-called tube length). The magnification power was again designed to be 25×. A similar specimen-container integrated with a coupling tube was designed to directly connect to the microscope. The total length of this embodiment would be about 175 mm long.

### CONCLUSION, RAMIFICATIONS, AND SCOPE

According to the present invention, an integrated microscope with a removable transparent specimen-container that can be directly placed at just beyond the effective focal plane of said microscope provides schoolchildren with a simple inspection tool for instantaneous microscopic view of live specimens collected in the field.

The invention has been described above. Obviously, numerous modifications and variations of the present invention are possible in light of the above teachings. Such variations are not to be regarded as a departure from the spirit and scope of the invention and all such modifications as would be obvious to one skilled in the art are intended to be included within the scope of the following claims.

I claim:

1. An integrated microscopic viewing apparatus, comprising:
an eyepiece lens assembly;
an objective lens assembly being arranged to form a microscope with said eyepiece assembly;
a specimen-container holding means being coaxially coupled to said microscope and movable along the optical axis of said microscope against said objective lens; and
a removable transparent specimen-container being disposed in said specimen-container holding means and directly placed at just beyond the effective focal plane of said microscope.

2. The integrated microscopic viewing apparatus according to claim 1, wherein said eyepiece lens assembly and objective lens assembly are disposed in one construction, preferably tube.

3. The integrated microscopic viewing apparatus according to claim 1, wherein said eyepiece lens assembly and objective lens assembly are disposed in retractable separate constructions, preferably tubes.

4. The integrated microscopic viewing apparatus according to claim 1, wherein said eyepiece lens assembly consists of a single convex lens.

5. The integrated microscopic viewing apparatus according to claim 1, wherein said eyepiece lens assembly consists of a compound lens system.

6. The integrated microscopic viewing apparatus according to claim 1, wherein said objective lens assembly consists of a single convex lens.

7. The integrated microscopic viewing apparatus according to claim 1, wherein said objective lens assembly consists of a compound lens system.

8. The integrated microscopic viewing apparatus according to claim 1, wherein said eyepiece lens assembly is movable along the optical axis of said microscope against said objective lens assembly, providing a means of focus.

9. The integrated microscopic viewing apparatus according to claim 1, wherein said specimen-container is movable transversely for better positioning specimen in the field of view of said microscope.
